(19) United States
(12) Patent Application Publication
(10) Pub. No.: US 2017/0341165 A1
(43) Pub. Date: Nov. 30, 2017

(54) SCROLL SAW

(71) Applicant: REXON INDUSTRIAL CORP., LTD., Taichung (TW)

(72) Inventor: Ming-Wei CHEN, Taichung (TW)

(21) Appl. No.: 15/602,670

(22) Filed: May 23, 2017

(30) Foreign Application Priority Data
May 24, 2016 (TW) 10 5116097

(51) Int. Cl. B23D 51/16; B23D 51/14

(52) U.S. Cl. CPC B23D 51/16; B23D 51/14

(57) ABSTRACT

A scroll saw includes a base providing a worktable, a motor mounted in the base and having an output shaft, a transmission unit mounted in the base and including first and second transmission devices respectively connected to the two opposite ends of the output shaft of the motor and respectively disposed above and below the worktable, and a saw blade having opposing top and bottom ends respectively connected to the first and second transmission devices of the transmission unit. Thus, when the motor is started, the first and second transmission devices are driven to alternatively move forward and backward in a reciprocating action, and the saw blade is driven to move up and down in a reciprocating action, avoiding vibration of the saw blade and the base and enhancing cutting stability.

### BACKGROUND OF THE INVENTION

### 1. Field of the Invention

The present invention relates to saw machine technology and more particularly, to a scroll saw that enhances cutting stability.

### 2. Description of the Related Art

U.S. Pat. No. 6,393,957 discloses a scroll saw, wherein when two links are driven by the motor, rocker levers and a rocker member are forced by the links to move the saw blade up and down in a reciprocation action to perform a cutting operation. However, when moving the saw blade up and down in the reciprocating action, the saw blade can easily be driven by the rocker levers to swing forward and backward, causing vibration or even saw blade damage. When saw blade vibration occurs, the cutting stability is affected.

### SUMMARY OF THE INVENTION

The present invention has been accomplished under the circumstances in view. It is the main object of the present invention to provide a scroll saw, which reduces saw blade and base vibration, enhancing cutting stability.

To achieve this and other objects of the present invention, a scroll saw comprises a base, a motor, a transmission unit and a saw blade. The base comprises a worktable. The worktable defines a work surface for bearing a workpiece to be cut. The motor is mounted in the base, and comprises an output shaft. The output shaft defines a first end and an opposing second end. The first end is disposed at an elevation higher than the work surface of the worktable of the base. The second end is disposed at an elevation lower than the work surface of the worktable of the base. The transmission unit is mounted in the base, and comprises a first transmission device and a second transmission device. The first transmission device and the second transmission device extend in direction perpendicular to the axial direction of the output shaft of the motor. The first transmission device and the second transmission device are respectively connected to the opposing first and second ends of the output shaft of the motor so that the first transmission device and the second transmission device are drivable by the motor to alternatively move forward and backward in a reciprocating action. Two opposite ends of the saw blade are respectively connected to the first transmission device and the second transmission device so that the saw blade is driven to move up and down in a reciprocating action when the first transmission device and the second transmission device are driven by the motor to alternatively move forward and backward in a reciprocating action.

As can be seen from the above, the scroll saw of the present invention uses the motor to drive the first and second transmission devices to move alternatively forward and backward in a reciprocating motor for carrying the saw blade to perform a cutting operation, thus, the invention enables the saw blade to be driven to move evenly, avoiding vibration of the saw blade and the base and enhancing cutting stability.

Further, the first transmission device comprises a first rotating wheel, a first link and a first swing arm. The first rotating wheel is connected to the first end of the output shaft of the motor, and comprises a first eccentric shaft. The first eccentric shaft is pivotally connected to one end of the first link. An opposite end of first link is pivotally connected to one end of the first swing arm. An opposite end of the first swing arm is connected to the saw blade. The second transmission device comprises a second rotating wheel, a second link and a second swing arm. The second rotating wheel is connected to the second end of the output shaft of the motor, and comprises a second eccentric shaft. The second eccentric shaft is pivotally connected to one end of the second link. An opposite end of the second link is pivotally connected to one end of the second swing arm. An opposite end of the second swing arm is connected to the saw blade. Further, the second eccentric shaft of the second rotating wheel and the first eccentric shaft of the first rotating wheel are symmetrically disposed at two opposite sides relative to the axis of the output shaft of the motor. Thus, subject to the symmetric relationship between the first eccentric shaft of the first rotating wheel and the second eccentric shaft of the second rotating wheel, the first eccentric shaft and the second eccentric shaft are alternatively moved forward and backward in a reciprocating action when the first and second transmission devices are driven by the motor,.

Other and further advantages and features of the present invention will be understood by reference to the following specification in conjunction with the accompanying drawings.

### BRIEF DESCRIPTION OF THE DRAWINGS

FIG. 1 is an elevational view of a scroll saw in accordance with the present invention.

FIG. 2 is an elevational view of the scroll saw of the present invention after removal of the base.

FIG. 3 is a sectional view of a part of the scroll saw in accordance with the present invention, illustrating the saw blade moved upward.

FIG. 4 is similar to FIG. 3, illustrating the saw blade moved downward.

### DETAILED DESCRIPTION OF THE INVENTION

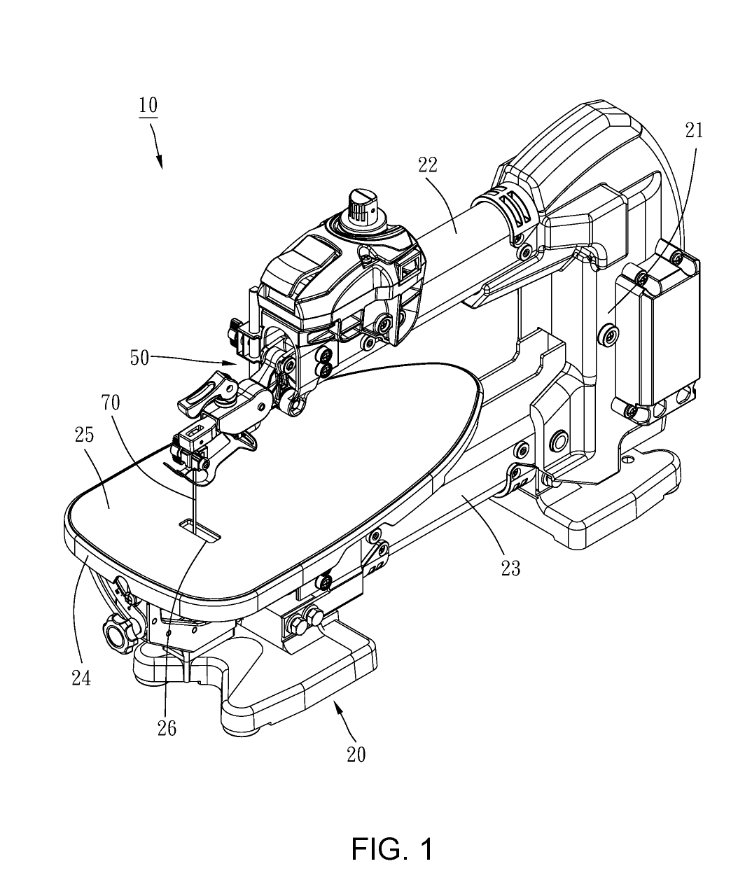

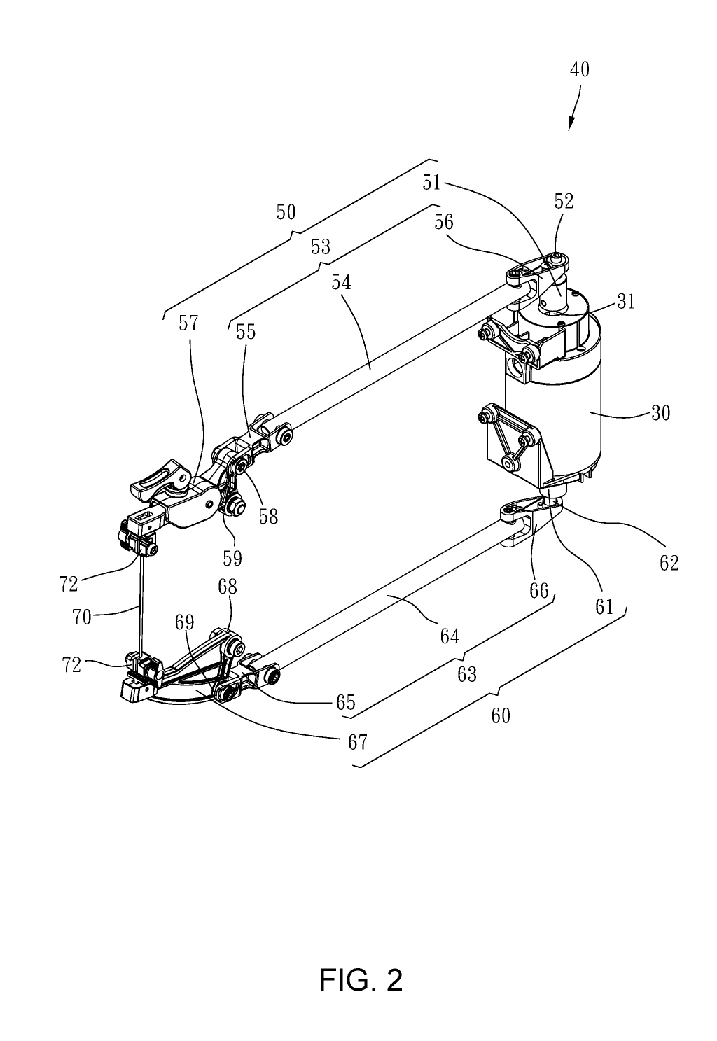

Referring to FIGS. 1 and 2, a scroll saw 10 in accordance with the present invention is shown. The scroll saw 10 comprises a base 20, a motor 30, a transmission unit 40, and a saw blade 70.

The base 20 comprises an upright pillar 21, a first support arm 22 and a second support arm 23. The upright pillar 21 has a top end connected with a rear end of the first support arm 22, and an opposing bottom end connected with a rear end of the second support arm 23. The base 20 further comprises a worktable 24 mounted between the first and second support arms 22,23 such that the first support arm 22 suspends above the worktable 24 and the second support arm 23 is disposed below the worktable 24. The worktable 24 comprises a work surface 25 adapted for bearing a workpiece to be cut (not shown), and a sawing slot 26 cut through the work surface 25.

The motor 30 is mounted in the upright pillar 21 of the base 20 to provide the necessary driving force. The motor 30 comprises an output shaft 31. The output shaft 31 defines a first end 32, and an opposing second end 33. The elevation of the first end 32 is above the elevation of the work surface 25 of the worktable 24 of the base 20. The elevation of the second end 33 is below the elevation of the work surface 25 of the worktable 24 of the base 20.

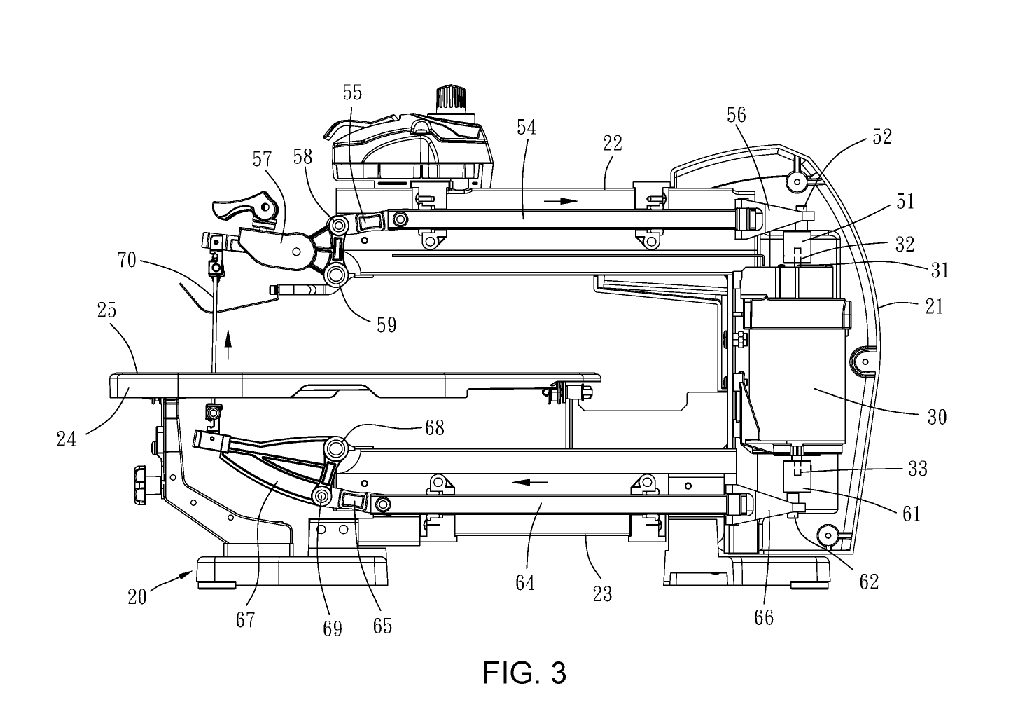

Referring to FIG. 3 and FIG. 2 again, the transmission unit 40 comprises a first transmission device 50 and a second transmission device 60. The first transmission device 50 comprises a first rotating wheel 51, a first link 53 and a first swing arm 57.

The first rotating wheel 51 is mounted in the upright pillar 21 of the base 20 and connected to the first end 32 of the output shaft 31 of the motor 30. The first rotating wheel 51 comprises a first eccentric shaft 52.

The first link 53 is mounted in the first support arm 22 of the base 20, and extends in direction perpendicular to the axial direction of the output shaft 31 of the motor 30. The first link 53 comprises a first shank 54, a first front coupling 55, and a first rear coupling 56. The first front coupling 55 has a rear end pivotally connected to a front end of the first shank 54. The first rear coupling 56 has opposing front and rear ends respectively pivotally connected to an opposing rear end of the first shank 54 and the first eccentric shaft 52 of the first rotating wheel 51.

The first swing arm 57 is disposed outside the base 20. The first swing arm 57 comprises a first upper coupling portion 58 and a first lower coupling portion 59 respectively located at a rear end thereof. The first upper coupling portion 58 is pivotally connected to the front end of the first front coupling 55 of the first link 53. The first lower coupling portion 59 is pivotally connected to the front end of the first support arm 22 of the base 20.

The second transmission device 60 comprises a second rotating wheel 61, a second link 63 and a second swing arm 67.

The second rotating wheel 61 is mounted in the upright pillar 21 of the base 20 and connected to the second end 33 of the output shaft 31 of the motor 30. The second rotating wheel 61 comprises a second eccentric shaft 62. The second eccentric shaft 62 and the first eccentric shaft 52 of the first rotating wheel 51 are symmetrically disposed at two opposite sides relative to the axis of the output shaft 31 of the motor 30.

The second link 63 is mounted in the second support arm 23 of the base 20, and extends in direction perpendicular to the axial direction of the output shaft 31 of the motor 30, i.e., the extending direction of the second link 63 is parallel to the extending direction of the first link 53. The second link 63 comprises a second shank 64, a second front coupling 65 and a second rear coupling 66. The second front coupling 65 has a rear end pivotally connected to a front end of the second shank 64. The second rear coupling 66 has opposing front and rear ends respectively pivotally connected to an opposing rear end of the second shank 64 and the second eccentric shaft 62 of the second rotating wheel 61.

The second swing arm 67 is disposed outside the base 20. The second swing arm 67 comprises a second upper coupling portion 68 and a second lower coupling portion 69 respectively located at a rear end thereof The second upper coupling portion 68 is pivotally connected to the front end of the second support arm 23 of the base 20. The second lower coupling portion 69 is pivotally connected to the front end of the second front coupling 65 of the second link 63.

The saw blade 70 is inserted through the sawing slot 26 of the worktable 24, having opposing top and bottom ends thereof respectively connected to a respective saw blade mounting block 72. These two saw blade mounting blocks 72 are respectively fixedly mounted to the front end of the first swing arm 57 of the first transmission device 50 and the front end of the second swing arm 67 of the second transmission device 60.

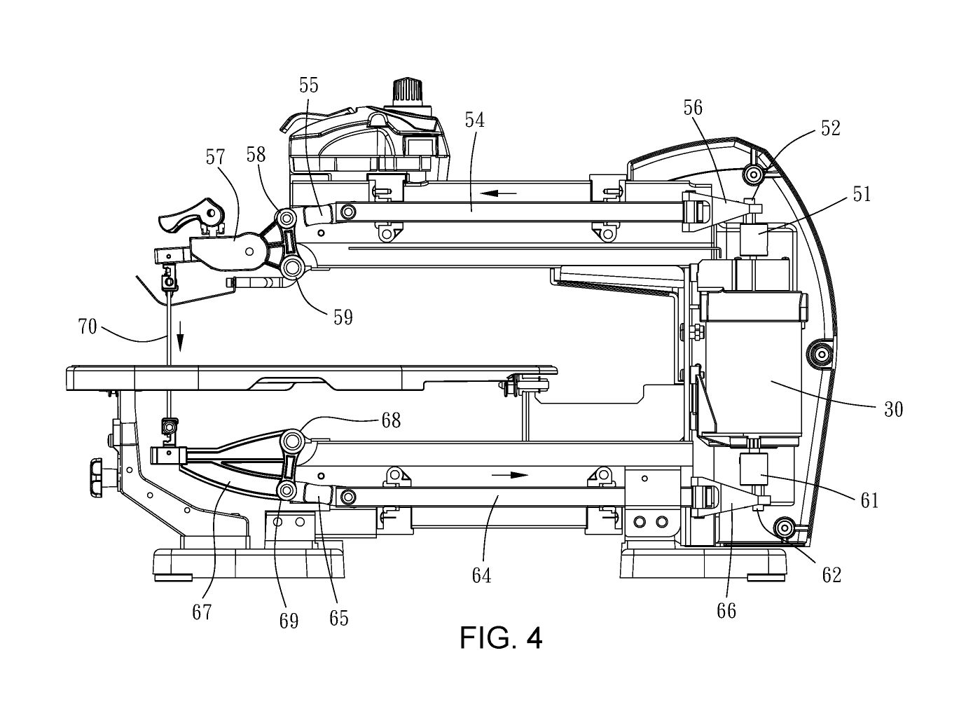

Referring to FIG. 4 and FIG. 3 again, when the motor 30 is started, the output shaft 31 of the motor 30 is rotated, causing the first and second ends 32, 33 of the output shaft 31 to rotate the first and second rotating wheels 51, 61 respectively. During rotation of the first and second rotating wheels 51, 61, the first and second eccentric shafts 52, 62 are driven to move the first and second links 53, 63 forward and backward in a reciprocating action. Since the second eccentric shaft 62 and the first eccentric shaft 52 of the first rotating wheel 51 are symmetrically disposed at two opposite sides relative to the axis of the output shaft 31 of the motor 30, when the first eccentric shaft 52 of the first rotating wheel 51 forces the first link 53 to move forward during the operation of the motor 30 to rotate the first and second rotating wheels 51, 61, the second eccentric shaft 62 of the second rotating wheel 61 forces the second link 63 to move backward. Conversely, when the first eccentric shaft 52 of the first rotating wheel 51 forces the first link 53 to move backward during the operation of the motor 30 to rotate the first and second rotating wheels 51, 61, the second eccentric shaft 62 of the second rotating wheel 61 forces the second link 63 to move forward. This action is repeated again and again. Thus, the first and second links 53, 63 are alternatively moved forward and backward. When the first and second links 53, 63 are alternatively moved forward and backward, the first and second swing arms 57, 67 are respectively and alternatively biased up and down on the axis of the first lower coupling portion 59 and the axis of the second coupling portion 68, driving the saw blade 70 to move alternatively up and down in a reciprocating action, and thus, the saw blade 70 is driven to cut the workpiece.

As can be seen from the foregoing, the scroll saw 10 of the present invention utilizes the symmetric arrangement of the first and second rotating wheels 51, 61 to let the first and second links 53, 63 be alternatively moved forward and backward in a reciprocating action. Unlike the synchronous action of the top and bottom links of the prior art design, the invention enables the saw blade 70 to be driven to move evenly, avoiding vibration of the saw blade 70 and the base 20 and enhancing cutting stability.

What is claimed is:

1. A scroll saw, comprising:
a base comprising a worktable defining a work surface;
a motor mounted in said base, said motor comprising an output shaft, said output shaft defining a first and an opposing second end, said first end being disposed at an elevation higher than said work surface of said worktable of said base, said second end being disposed at an elevation below said work surface of said worktable of said base;
a transmission unit mounted in said base, said transmission unit comprising a first transmission device and a second transmission device, said first transmission device and said second transmission device respectively extending in a perpendicular manner relative to the axial direction of said output shaft of said motor, said first transmission device and said second transmission device being respectively connected to said first end and said second end of said output shaft of said motor so that said first transmission device and said second transmission device are drivable by said motor to alternatively move forward and backward in a reciprocating action; and
a saw blade, said saw blade having two opposite ends respectively connected to said first transmission device and said second transmission device so that said saw blade is driven to move up and down in a reciprocating action when said first transmission device and said second transmission device are driven by said motor to alternatively move forward and backward in a reciprocating action.

2. The scroll saw as claimed in claim 1, wherein said first transmission device comprises a first rotating wheel, a first link and a first swing arm, said first rotating wheel being connected to said first end of said output shaft of said motor and comprising a first eccentric shaft, said first eccentric shaft being pivotally connected to one end of said first link, said first link having an opposite end pivotally connected to one end of said first swing arm, said first swing arm having an opposite end connected to said saw blade; said second transmission device comprising a second rotating wheel, a second link and a second swing arm, said second rotating wheel being connected to said second end of said output shaft of said motor and comprising a second eccentric shaft, said second eccentric shaft being pivotally connected to one end of said second link, said second link having an opposite end pivotally connected to one end of said second swing arm, said second swing arm having an opposite end connected to said saw blade; said second eccentric shaft of said second rotating wheel and said first eccentric shaft of said first rotating wheel are symmetrically disposed at two opposite sides relative to the axis of said output shaft of said motor.

3. The scroll saw as claimed in claim 1, wherein said first link comprises a first shank, a first front coupling and a first rear coupling, said first front coupling having two opposite ends respectively pivotally connected to said first shank and said first swing arm, said first rear coupling having two opposite ends respectively pivotally connected to said first shank and said first eccentric shaft of said first rotating wheel; said second link comprises a second shank, a second front coupling and a second rear coupling, said second front coupling having two opposite ends respectively pivotally connected to said second shank and said second swing arm, said second rear coupling having two opposite ends respectively pivotally connected to said second shank and said second eccentric shaft of said second rotating wheel.

4. The scroll saw as claimed in claim 3, wherein said base comprises a first support arm disposed above said worktable and a second support arm disposed below said worktable; said first link and said second link are respectively mounted in said first support arm and said second support arm of said base; said first swing arm comprises a first upper coupling portion pivotally connected to said first front coupling of said first link and a first lower coupling portion pivotally connected to said first support arm of said base; said second swing arm comprises a second upper coupling portion pivotally connected to said second support arm of said base and a second lower coupling portion pivotally connected to said second front coupling of said second link.
